(19) United States
(12) Patent Application Publication
(10) Pub. No.: US 2017/0329925 A1
(43) Pub. Date: Nov. 16, 2017

(54) METHOD AND SYSTEM FOR DETERMINING AN ESTIMATED SURVIVAL TIME OF A SUBJECT WITH A MEDICAL CONDITION

(71) Applicant: Macau University of Science and Technology, Taipa (MO)

(72) Inventors: Yong Liang, Taipa (MO); Hua Chai, Taipa (MO); Zi-yi Yang, Taipa (MO); Xiao-Ying Liu, Taipa (MO)

(21) Appl. No.: 15/150,580

(22) Filed: May 10, 2016

(51) Int. Cl. G06F 19/00; G06F 17/18

(52) U.S. Cl. CPC G06F 19/3437; G06F 17/18

(57) ABSTRACT

A system and a method for determining an estimated survival time of a subject with a medical condition utilizes the novel RS-AFT model and is especially suitable and highly advantageous for survival analysis based on microarray gene expression data because of its exceptional performance of gene selection, stable noise resistance, and high prediction precision.

### TECHNICAL FIELD

The present invention relates to a system and a method for determining an estimated survival time of a subject with a medical condition, in particularly, but not exclusively, to a system for determining an estimated survival time of a subject with cancer based on one or more biological features selected from presence of gene, gene expression, presence of gene product and/or amount of gene product, in particular selected from gene expression.

### BACKGROUND

Accurate prediction for the survival time of cancer patients based on the microarray gene expression datasets with high-dimensionality and low-sample size is attractive but challenging. The efficient identification of significantly relevant genes associated with tumors may be helpful to discover novel information and a new way for clinical research, and even to find the new targets of anti-cancer drug. The challenge of survival analysis is that a large part of samples in the datasets is censored, which cannot be used for prediction model training and significantly reduces the predictor's performance.

To identify the relevant biomarkers for diseases, various regression approaches with different penalization operations have been adopted. Nevertheless, the extreme noise especially in microarray gene expression data significantly reduces the prediction accuracy of the regularization methods.

There remains, thus, a strong need for systems and respective methods suitable for determining the survival time of subjects in the medical field such as based on microarray gene expression data with sufficient prediction capability and sufficient capability for biomarker selection. Clearly, having such system and method could significantly contribute to an improved diagnosis and treatment selection.

### SUMMARY OF THE INVENTION

In accordance with a first aspect of the present invention, there is provided a method for determining an estimated survival time of a subject with a medical condition, comprising the steps of:

obtaining a dataset comprising biological data of a plurality of sample subjects, the biological data of each sample subject includes one or more biological features and a time value associated with a survival time;

applying at least part of the dataset to a parametric survival model to solve the parametric survival model by determining one or more parameters in the parametric survival model; and

processing biological data of a sample subject with the medical condition with the solved parametric survival model to determine an estimated survival time of the sample subject;

wherein the parametric survival model is a modified accelerated failure time model that applies least absolute deviation and L_{q}-type regression method with 0<q≦1.

In an embodiment, the estimated survival time of the sample subject is determined based on one or more biological features in the biological data of the sample subject in the processing step.

The estimated survival time of a subject can preferably but not exclusively be determined based on expression levels of one or more genes, at least some of them or all of them representing biomarkers for the medical condition such as cancer or a cancer subtype. The term “biomarker” as used herein in particular means biological features like presence of genes, gene expression, presence of gene products or amount of gene products that are indicative of the medical condition like cancer of the subject. “Indicative of the medical condition” as expression used herein means that the biological feature is found at all or is found significantly more often in subjects with the medical condition than in healthy subjects or in subjects suffering from another medical condition and is in particular associated with the medical condition, i.e. there is a link or connection between the biological feature and the medical condition or such link or connection is assumed.

The biological data of each of the plurality of sample subjects is in an embodiment in a form of:

(yᵢ,δᵢ,xᵢ)ᵢ₌₁ⁿ

yᵢ=min((tᵢ,cᵢ) with yᵢ being the time value associated with the survival time, tᵢ being a real survival time and cᵢ being a censoring survival time, of an i^{th} sample subject; δ is a censoring indicator in which δᵢ=0 represents a right-censoring time, and δᵢ=1 represents a real completed time; xᵢ=(xᵢ₁, . . . xᵢₚ) are p dimensional covariates representing the one or more biological features of the i^{th} sample subject.

In an embodiment, in particular in the afore-mentioned embodiment, the parametric survival model is defined by at least in part by

h(yᵢ)=xᵢ^{T}β+εᵢ, i=1, . . . , n

where function h( ) is a monotone function; εᵢ are independent random errors with a normal distribution function; and β=(β₁,β₂, . . . , βₚ) is the regression coefficient vector of p variables representing the one or more parameters to be determined. In this embodiment, the function h( ) can be a logarithmic function and the one or more parameters can be determined at least in part by:

$${β}_{LAD} = argmin \{ {\sum }_{i = 1}^{n} \vert h ( {y}_{i} ) - {x}_{i}^{T} β \vert + {\sum }_{j = 1}^{p} λ {\vert {β}_{j} \vert}^{q} \}$$

with 0<q≦1, and λ is an optimization parameter.

In an embodiment, in particular in the afore-mentioned embodiments, for δᵢ=0 the method further comprises the steps of:

determining an estimated model survival time using the censoring survival time based on Kaplan-Meier estimation method, where

$$h ( {y}_{i} ) = ( {δ}_{i} ) h ( {y}_{i} ) + ( 1 - {δ}_{i} ) {\{ \hat{S} ( {y}_{i} ) \}}^{- 1} {\sum }_{{t}_{( r )} > t} h ( {t}_{( r )} ) Δ \hat{S} ( {t}_{( r )} )$$

with h(yᵢ) being the estimated model survival time; yᵢ being the censoring survival time; and ΔŜ(t₍ᵣ₎)) is a step function at time t(r); and

applying the estimated model survival time to the parametric survival model to facilitate determination of the one or more parameters in the parametric survival model.

In an embodiment, such as in an afore-mentioned embodiment, the method further comprises the step of:

determining the optimization parameter λ using Bayesian information criterion. In this embodiment, the: optimization parameter λ can be determined as:

$$λ = \frac{log ( n )}{{\vert {β}_{LAD} \vert}^{q}}$$

with 0<q≦1.

In an embodiment, the method further comprises the step of:

solving the parametric survival model to determine an effect of the one or more biological features on the estimated survival time. In this embodiment, the parametric survival model can be solved using a weighted iterative linear programming method. The weighted iterative linear programming method can comprise the steps of:

setting t=0 and β^{t}=β_{LAD} for t=0;

determining the values of β^{t+1} using

$${β}^{t + 1} = argmin \{ {\sum }_{i = 1}^{n} \vert h ( {y}_{i} ) - {x}_{i}^{T} β \vert + {\sum }_{j = 1}^{p} \frac{log ( n )}{\vert {β}_{j}^{t} \vert} \vert {β}_{j} \vert \} ;$$

and

iterating the β^{t} value determination step for increasing value of t until a convergence criterion is met.

In an embodiment, the sample subjects are animals or humans, in particular mammals. Preferably, the sample subjects are humans. The dataset is in an embodiment obtained from cancerous tissue of the sample subjects. In an embodiment, the one or more biological features are selected from presence of a gene, gene expression, presence of a gene product and/or amount of a gene product. In particular the biological feature is a gene expression, i.e. a gene expression level, and preferably more than one biological feature is comprised in the biological data of each sample subject. In an embodiment, the medical condition is cancer or a subtype of cancer.

In a preferred embodiment, the sample subjects are humans; the one or more biological features are: presence of a gene, gene expression, presence of a gene product or amount of a gene product; and the medical condition is cancer.

In accordance with a second aspect of the present invention, there is provided a system for determining an estimated survival time of a subject with a medical condition, comprising one or more processors arranged to:

apply a dataset that comprises biological data of a plurality of sample subjects to a parametric survival model to solve the parametric survival model by determining one or more parameters in the parametric survival model, wherein the biological data of each sample subject includes one or more biological features and a time value associated with a survival time; and

process biological data of a sample subject with the medical condition with the solved parametric survival model to determine an estimated survival time of the sample subject based on one or more biological features in the biological data of the sample subject;

wherein the parametric survival model is a modified accelerated failure time model that applies least absolute deviation and L_{q}-type regression methods with 0<q≦1.

In an embodiment of the system of the present invention, the biological data of each of the plurality of sample subjects is in a form of:

(yᵢ,δᵢ,xᵢ)ᵢ₌₁ⁿ

where yᵢ=min(tᵢ,cᵢ) with yᵢ being the time value associated with the survival time, tᵢ being a real survival time and cᵢ being a censoring survival time, of an i^{th} sample subject; δ is a censoring indicator in which δᵢ=0 represents a right-censoring time, and δᵢ=1 represents a real completed time; xᵢ=(xᵢ₁, . . . xᵢₚ) are p dimensional covariates representing the one or more biological features of the i^{th} sample subject.

In this embodiment, the parametric survival model can be defined by at least in part by

h(yᵢ)=xᵢ^{T}β+εᵢ, i=1, . . . , n

where function h( ) is a logarithmic function; εᵢ are independent random errors with a normal distribution function; and β=(β₁,β₂,. . . ,βₚ) is the regression coefficient vector of p variables representing the one or more parameters to be determined.

In an embodiment, in particular in the afore-mentioned embodiment of the system of the present invention, the one or more processors are arranged to determine the one or more parameters based at least in part on:

$${β}_{LAD} = argmin \{ {\sum }_{i = 1}^{n} \vert h ( {y}_{i} ) - {x}_{i}^{T} β \vert + {\sum }_{j = 1}^{p} λ {\vert {β}_{j} \vert}^{q} \}$$

with 0<q≦1, and λ is an optimization parameter.

In an embodiment of the system of the present invention, the one or more processors are arranged to solve the parametric survival model using a weighted iterative linear programming method and to determine an effect of the one or more biological features on the estimated survival time.

In an embodiment, the sample subjects are animals or humans, in particular mammals. Preferably, the sample subjects are humans. In an embodiment, the one or more biological features are selected from presence of a gene, gene expression, presence of a gene product and/or amount of a gene product. In particular the biological feature is selected from gene expression, i.e. a gene expression level, and preferably more than one biological feature is comprised in the biological data of each sample subject. In an embodiment, the medical condition is cancer or a subtype of cancer.

In a preferred embodiment of the system of the present invention, the sample subjects are humans; the one or more biological features are: presence of a gene, gene expression, presence of a gene product or amount of a gene product; and the medical condition is cancer.

In an embodiment, the system further comprises a display arranged to display the determined estimated survival time of the sample subject.

In another aspect, there is provided a non-transient computer readable medium for storing computer instructions that, when executed by one or more processors, causes the one or more processors to perform a method for determining an estimated survival time of a subject with a medical condition, comprising the steps described above.

Other features and aspects of the invention will become apparent by consideration of the following detailed description and accompanying drawings.

### BRIEF DESCRIPTION OF THE DRAWINGS

FIG. 1 is a schematic diagram of a computer or computing server arranged to operate a system of the present invention for determining an estimated survival time of a subject with a medical condition.

FIG. 2 is a schematic diagram showing a system of the present invention for determining an estimated survival time of a subject with a medical condition.

FIG. 3 shows MSE values obtained by different AFT models in different parameter settings.

FIG. 4 shows MSE values obtained by different AFT models at different noise control parameter settings.

### DETAILED DESCRIPTION OF THE INVENTION

The inventors based on their research, tests and experiments concluded that although in the last two decades, the Cox proportional hazards (Cox) model with the regularization approach has been widely used for the patient risk classification and relevant biomarkers extraction (Tibshirani, R., Stat. Med. 16, 385-395, Gui J. and Li, H., Bioinformatics 21, 3001-3008, Liu, C. et al., Appl. Soft Comput. 14(c), 498-503), the proportional hazards assumption for the Cox model may not be suitable for some particular applications.

In the light of the fact that the prediction of the patient's survival time has become a very important requirement in the clinical treatments, the accelerated failure time (AFT) model has already become one succedaneum of the Cox model in survival analysis. One of the main reason that the AFT model is not used as widely as the Cox proportional hazards model are the difficulties in computing the semi-parametric estimators, even if the number of covariates is very small. To improve the available sample size from the censored data and get better prediction accuracy, some imputation methods were used in the AFT model. One of them is called Buckley-James estimator (Buckley J. and James, I., Biometrika 66, 429-436, Tsiatis, A., Ann. Stat 18, 354-372, Huang, J. et al., Biometrics 62, 813-820), which adjusts censored observations using the Kaplan-Meier approach; another one is the rank based estimator, which can be motivated from the score function of the partial likelihood (Cai, T. et al., Biometrics 65, 394-404, Jin, Z. et al., Biometrika 90, 341-353). AS a lot of datasets available has characteristics of high-dimensionality and low sample size, it becomes more difficult to apply these survival analysis methods, such as the Cox and AFT models, or their regularized versions, especially when variable selection is needed along with estimation. In order to simplify the method, the inventors herein based on their research and experiments used the Kaplan-Meier weights approach (Kaplan E. L. and Meier, P., J. Am. Stat. Assoc. 53, 457-481) to estimate the censored data in the implementation of a AFT model.

To solve the AFT model, the traditional ordinary least squares (OLS) approach has been used for long time. However, in survival analysis, the microarray gene expression data usually contains high level of noise. Generally, the OLS approach is sensitive to noise, which significantly reduces its robustness in the practical application. Meanwhile, the OLS estimation although can achieve an unbiased solution under some certain conditions, its estimated variance is quite large. To improve the performance of the OLS estimation, the robust regression and the regularization methods were proposed. The least absolute deviation (LAD) is the kind of the robust regression method to confront the high level noise. The regularization approaches are widely used for variable selection in high dimensional data analysis. To overcome the shortcomings in the OLS methods, Li et al. (Li, W. et al., Proceedings of the Six International Conference on Data Mining. Washington: IEEE Computer Society, 690-700) proposed a RLAD method that combines the robust regression and regularization approaches together. After that, the LAD-Lasso (Wang, H. et al., J Business Economic Statist, 25: 347-355) and LAD-Adaptive Lasso (Xu, J. F. and Ying, Z. L., Ann Inst Stat Math, 62: 487-514) were implemented. However, compared with the L₁ type regularization, the L_{q} (0<q<1) regularization can obtain more sparse results, and satisfies some rigorous statistic properties, such as oracle property, consistency of variable selection, and unbiasedness (Xu, Z. B. et al., Sci China Ser F, 53: 1159-1169 , Chartrand, R. and Staneva, V., Inverse Problems, 24: 1-14). Therefore, Chang et al. (Sci Sin Math, 40(10): 985-998, doi: 10.1360/012010-77) proposed LAD-L_{q} regularization, which outperforms some existing methods based on the ordinary least squares (OLS) and L₁ penalization approaches in variable selection.

For survival analysis, the inventors herein based on their research discovered that the L_{1/2} regularization can be applied for relevant gene selection under the AFT model. They implemented the robust sparse AFT model (RS-AFT) with LAD-L_{q} regularization approaches.

Without being bound by theory, the inventors herein through their research, tests and experiments discovered that the novel robust sparse accelerated failure time model (RS-AFT) through the least absolute deviation (LAD) and L_{q} penalization can be used in a system for survival prediction and biomarker selection, particularly based on noisy microarray gene expression data. To solve the RS-AFT model, the inventors discovered an iterative weighted linear programming method without regularization parameter tuning.

In this embodiment, the system for determining an estimated survival time of a subject with a medical condition is implemented by or for operation on a computer having an appropriate user interface. The computer may be implemented by any computing architecture, including stand-alone PC, client/server architecture, “dumb” terminal/mainframe architecture, or any other appropriate architecture. The computing device is appropriately programmed to implement the invention.

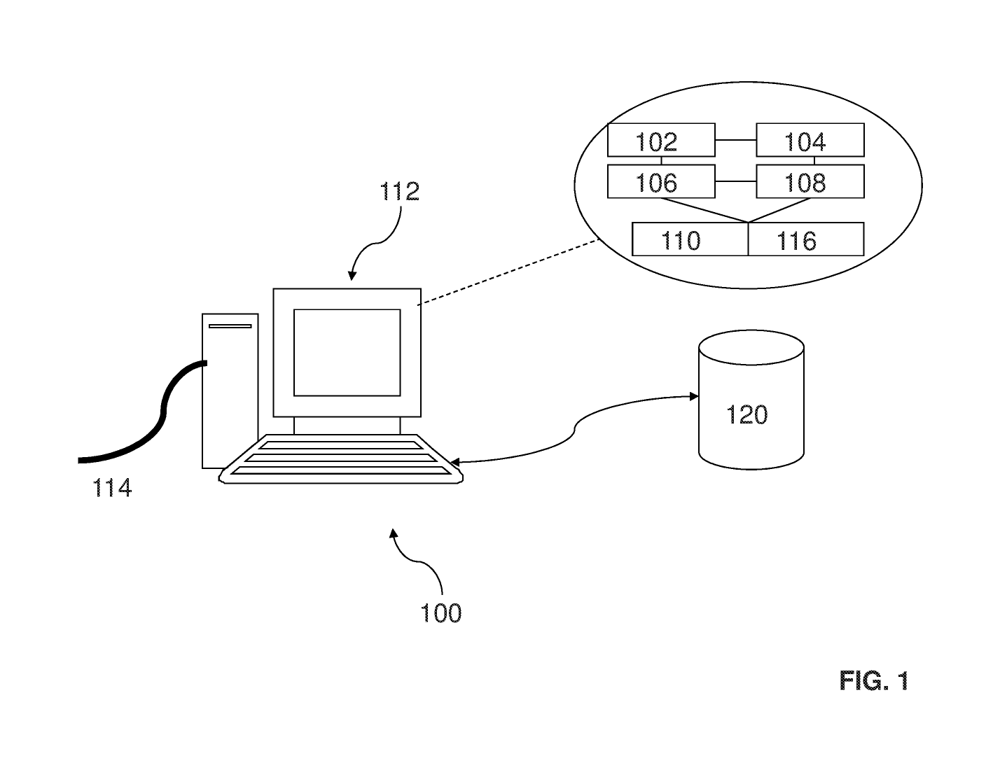

Referring to FIG. 1, there is a shown a schematic diagram of a computer or a computing server 100 which in this embodiment comprises a server 100 arranged to operate, at least in part if not entirely, the system for determining an estimated survival time of a subject with a medical condition in accordance with one embodiment of the present invention. The server 100 comprises suitable components necessary to receive, store and execute appropriate computer instructions. The components may include a processing unit 102, read-only memory (ROM) 104, random access memory (RAM) 106, and input/output devices such as disk drives 108, input devices 110 such as an Ethernet port, a USB port, etc., display 112 such as a liquid crystal display, a light emitting display or any other suitable display and communications links 114. The server 100 includes instructions that may be included in ROM 104, RAM 106 or disk drives 108 and may be executed by the processing unit 102. There may be provided a plurality of communication links 114 which may variously connect to one or more computing devices such as a server, personal computers, terminals, wireless or handheld computing devices. At least one of a plurality of communications link may be connected to an external computing network through a telephone line or other type of communications link.

The server 100 may include storage devices such as a disk drive 108 which may encompass solid state drives, hard disk drives, optical drives or magnetic tape drives. The server 100 may use a single disk drive or multiple disk drives. The server 100 may also have a suitable operating system 116 which resides on the disk drive or in the ROM of the server 100.

The system has a database 120 residing on a disk or other storage device which is arranged to store a dataset. The database 120 is in communication with the server 100 with an interface, which is implemented by computer software residing on the server 100. Alternatively, the database 120 may also be implemented as a stand-alone database system in communication with the server 100 via an external computing network, or other types of communication links.

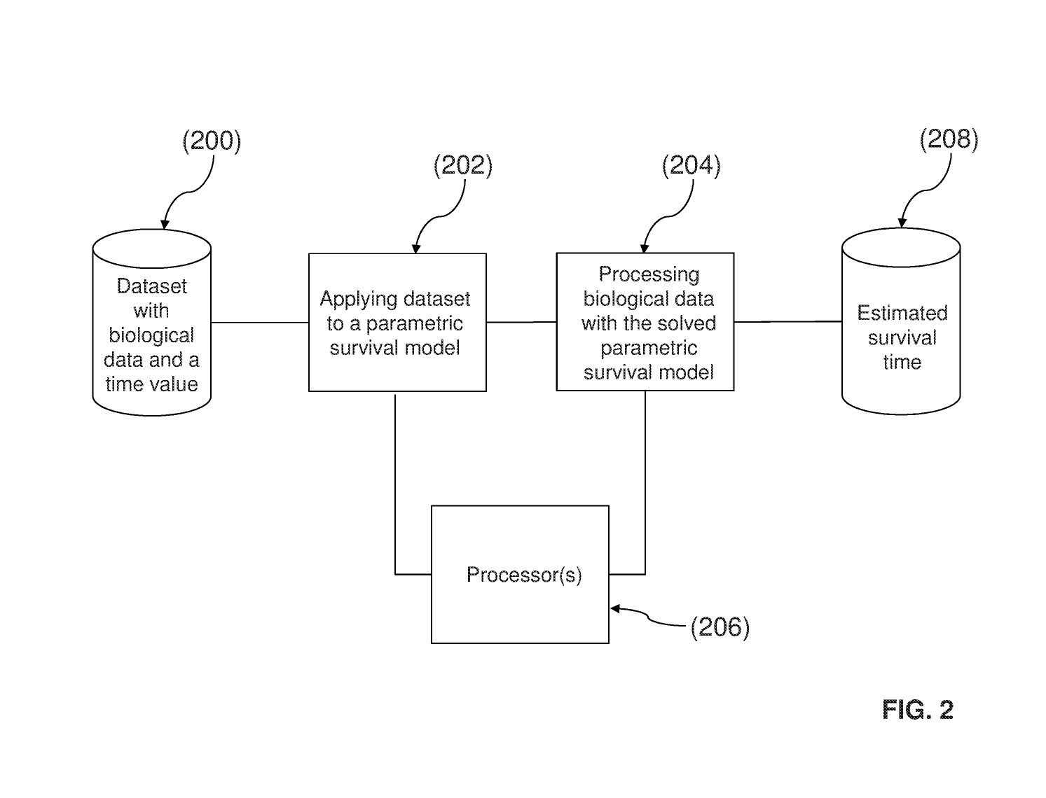

With reference to FIG. 2, there is provided a system for determining an estimated survival time of a subject with a medical condition, comprising one or more processors 206 arranged to:

apply a dataset 200 that comprises biological data of a plurality of sample subjects to a parametric survival model to solve the parametric survival model (202) by determining one or more parameters in the parametric survival model, wherein the biological data of each sample subject includes one or more biological features and a time value associated with a survival time; and

process biological data of a sample subject with the medical condition with the solved parametric survival model (204) to determine an estimated survival time of the sample subject (208) based on one or more biological features in the biological data of the sample subject;

wherein the parametric survival model is a modified accelerated failure time model that applies least absolute deviation and L_{q}-type regression methods with 0<q≦1.

In this embodiment, the system may include one or more processors (206) each arranged to apply at least part of a dataset 200 that comprises biological data of a plurality of sample subjects which are humans including one or more biological features in form of gene expression levels and a time value associated with a survival time to a parametric survival model to solve the parametric survival model (202) by determining one or more parameters in the parametric survival model.

The parametric survival model is a novel robust sparse accelerated failure time model (RS-AFT) based on least absolute deviation (LAD) and L_{q} regularization for survival prediction and biomarker selection. To solve the RS-AFT model, an iterative weighted linear programming method can be used without regularization parameter tuning. The one or more processors (206) are further each arranged to process biological data of a sample subject with the medical condition, in particular cancer, with the solved parametric survival model (204). The system, thus allows determining an estimated survival time of the sample subject (208) in particular based on the expression of one or more genes which are preferably biomarkers for the medical condition.

These processes, which can include methods of the present invention, may be implemented as a plurality of steps on a computer or computing device, such as those as found in FIG. 1.

The system of the present invention utilizing the novel RS-AFT model is especially suitable and highly advantageous for survival analysis of microarray gene expression data, because of its good performance of gene selection, stable noise resistance and the high prediction precision.

Experimental results confirmed that the system with the new RS-AFT model outperforms existing survival prediction systems and respective methods, such as those based on Lasso, L_{1/2}, Elastic net and SCAD. The advantages of the system of the present invention include: 1) high prediction capability for subject's survival time; 2) high capability for relevant biological feature, in particular for biomarker selection; 3) high stability for the resistance of the noisy data, especially of microarray gene expression data.

Consequently, the present invention provides an advantageous system for survival analysis in clinical research.

Preferably but not exclusively, the system of the present invention can be used for predicting the estimated survival time of cancer patients based on gene expression levels including identifying biomarkers associated with cancer or a specific cancer subtype.

Further features, applications and advantages of the system and method of the present invention will be evident for a person skilled in the art from the features and embodiments described below relating to the RS-AFT model with the least absolute deviation and L_{q} regularization and an iterative weighted linear programming method to solve the RS-AFT model.

A dataset including n samples is considered for studying the correlations between the gene expression levels X and the survival time Y. The data form of

(yᵢ,δᵢ,xᵢ)ᵢ₌₁ⁿ

can be used to represent the individual patient' s sample, where

yᵢ=min(tᵢ,cᵢ)

is observed where tᵢ is the survival time, cᵢ is the time to the censoring event (e.g., study conclusion, date of final follow up). For subject i, δ is the censoring indicator, if δᵢ=0, it represents the right censoring time and δᵢ=1 means the completed time, xᵢ=(xᵢ₁, . . . xᵢₚ) indicates the p dimensional covariates. The AFT model is treated as a linear regression between the logarithm of response yᵢ and its corresponding covariates xᵢ: h(yᵢ)=xᵢ^{T}β+εᵢ, i=1, . . . , n, where h(.) is the log transformation or some other monotone function, εᵢ are the independent random errors with a normal distribution function, and β=(β₁,β₂, . . . ,βₚ) is the regression coefficient vector of p variables.

Due to the censoring time in the datasets, the standard least squares approach is not allowed to directly compute the regression parameters of the covariates in the AFT model. For high dimensional and low simple size data, the Kaplan-Meier weights estimator is more efficient than the Buckley-James and rank based approaches. Moreover, it has a strong and strict theoretical support under some reasonable conditions (Huang, J. et al., Biometrics 62, 813-82). In the implementation of the AFT model suggested buy the inventors herein, Kaplan-Meier weights approach can be used to estimate the censored data. The estimated value h(yᵢ) of the censoring survival time yᵢ is given by:

$$h ( {y}_{i} ) = ( {δ}_{i} ) h ( {y}_{i} ) + ( 1 - {δ}_{i} ) {\{ \hat{S} ( {y}_{i} ) \}}^{- 1} {\sum }_{{t}_{( r )} > t} h ( {t}_{( r )} ) Δ \hat{S} ( {t}_{( r )} )$$

where the ΔŜ(t₍ᵣ₎) is the step of at time t(r) (Datta, S., Stat. Methodol. 2, 65-69).

The least squares approach methods are widely used to find the coefficients β:

$${β}_{LS} = argmin {\sum }_{i = 1}^{n} {( h ( {y}_{i} ) - {x}_{i}^{T} β )}^{2}$$

To overcome the shortcomings of least squares approach, especially for data X with high level noise, the least absolute deviation (LAD) was adopted by the inventors herein, and the estimated value β is written as:

$${β}_{LAD} = argmin {\sum }_{i = 1}^{n} \vert h ( {y}_{i} ) - {x}_{i}^{T} β \vert$$

Not all genes in the microarray datasets may associate with the forecast of patients' survival time, which means some coefficients β of covariates may be zero in the true model. If the sample size tends to infinity, an ideal prediction procedure for survival analysis should select the key risk gene with non-zero coefficients consistently and efficiently. In practice, the regularization methods are widely used to solve the biomarker selection problem in the high-dimensionality and low-sample size datasets. The regularization term is added to the AFT model with the LAD approach as:

$${β}_{LAD} = argmin \{ {\sum }_{i = 1}^{n} \vert h ( {y}_{i} ) - {x}_{i}^{T} β \vert + λ Pen ( β ) \}$$

The AFT model with the LAD and the Lasso regularization approaches can be written as:

$$β = argmin \{ {\sum }_{i = 1}^{n} \vert h ( {y}_{i} ) - {x}_{i}^{T} β \vert + {\sum }_{j = 1}^{p} λ \vert {β}_{j} \vert \}$$

While 0<q<1, the L_{q} type regularization can get more sparse solutions. Therefore, the robust sparse AFT model with the LAD and the L_{q} approaches (RS-AFT) is given by:

$$β = argmin \{ {\sum }_{i = 1}^{n} \vert h ( {y}_{i} ) - {x}_{i}^{T} β \vert + {\sum }_{j = 1}^{p} λ {\vert {β}_{j} \vert}^{q} \}$$

Weighted iterative linear programming method for RS-AFT model: The RS-AFT model is a non-convex optimization problem and a weighted iterative method is suggested by the inventors herein to solve it. The regularization part |β|^{q} in the RS-AFT model can be replaced by the first-order Taylor expansion:

$${\vert β \vert}^{q} \approx {\vert {β}_{0} \vert}^{q} + \frac{1}{{\vert {β}_{0} \vert}^{1 - q}} ( \vert β \vert - \vert {β}_{0} \vert ) = \frac{\vert β \vert}{{\vert {β}_{0} \vert}^{1 - q}}$$

The minimization problem of the RS-AFT model can be written as:

$$β = argmin \{ {\sum }_{i = 1}^{n} \vert h ( {y}_{i} ) - {x}_{i}^{T} β \vert + {\sum }_{j = 1}^{p} \frac{λ}{{\vert {β}_{0 , j} \vert}^{1 - q}} \vert {β}_{j} \vert \}$$

In the literature (Chang, X. Y. et al., Sci Sin Math, 40(10): 985-998, doi: 10.1360/012010-77, Hurvich, C. M. and Tsai, C. L., Biometrika, 76, 297-307), the BIC method was used to select the optimal regularization parameter λ. The likelihood function of the posterior probability by BIC is given by:

$$l ( β ) = {\sum }_{i = 1}^{n} \vert h ( {y}_{i} ) - {x}_{i}^{T} β \vert + {\sum }_{j = 1}^{p} ( λ {\vert {β}_{j} \vert}^{q} - log ( λ ) log ( n ) - log ( n ) )$$

Minimizing the l(β), the value λ can be given as:

$${λ}_{n , j} = \frac{log ( n )}{{\vert {β}_{j} \vert}^{q}}$$

According to the literature (Chang, X. Y. et al., Sci Sin Math, 40(10): 985-998, doi: 10.1360/012010-77), |β_{LAD}|^{q} (β_{LAD} is obtained by the least absolute deviation of the AFT model) can be seen as the estimator of |β|^{q}, λ can be written as:

$$λ = \frac{log ( n )}{{\vert {β}_{LAD} \vert}^{q}}$$

Since the variable selection consistency of the L_{q} (0<q≦1) method has been proved in Chang et al. (Sci Sin Math, 40(10): 985-998, doi: 10.1360/012010-77), q was set=1 in the weighted iterative method. Therefore, a detail procedure of the weighted iterative method for the RS-AFT model in an embodiment can be as follows:

Step 1: Initial β⁰=β_{LAD}, β_{LAD} is obtained by the least absolute deviation of the AFT model, and set t=0;

Step 2:

$${β}^{t + 1} = argmin \{ {\sum }_{i = 1}^{n} \vert h ( {y}_{i} ) - {x}_{i}^{T} β \vert + {\sum }_{j = 1}^{p} \frac{log ( n )}{\vert {β}_{j}^{t} \vert} \vert {β}_{j} \vert \} ;$$

Step 3: Set iteration t=t+1; repeat Step 2 and update β^{t} until the stop criterion meeting.

In Step 2, the minimization problem can be solved using the linear programming method without the regularization parameter tuning.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilized. This will include standalone computers, network computers and dedicated hardware devices. Where the terms “computing system” and “computing device” are used, these terms are intended to cover any appropriate arrangement of computer hardware capable of implementing the function described.

It will be appreciated by persons skilled in the art that the term “database” may include any form of organized or unorganized data storage devices implemented in either software, hardware or a combination of both which are able to implement the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

### EXAMPLES

### Example 1

### Analysis of Simulated Data

The AFT model has been implemented and evaluated with five different regularization approaches (RS, Lasso, L_{1/2}, Elastic net (EN), SCAD) with simulated datasets.

Firstly, the vectors of independent standard normal distribution

γ₀,γᵢ₁,γᵢ₂, . . . ,γᵢₚ, (i=1,2, . . . ,n) were generated, then

xᵢⱼ/γᵢⱼ\sqrt{1−c}+γᵢ₀\sqrt{c}, (j=1, . . . ,p),

where c is the correlation coefficient, and the patient's survival time

$${y}_{i} = exp ( {\sum }_{j = 1}^{p} {β}_{ij} {x}_{ij} ) , ( j = 1 , 2 , … , p ) .$$

The number of the censoring data has been decided by the censoring rate, and the censoring time points yᵢ′ were determined from a random distribution accordingly. The observed survival time in the simulated data was defined as:

yᵢ=(yᵢ,yᵢ′), and δᵢ=I(yᵢ≦yᵢ′).

To test the performance of the AFT models with different regularization approaches in the noise environment, yᵢ=yᵢ+s·ε, was calculated where s and are the noise control parameter and the independent random errors from N(0,1) respectively. Finally, the simulated data were represented as

(yᵢ,δᵢ,xᵢ)

In order to make the simulated datasets in accordance with the high-dimensionality and low-sample size characteristics of the microarray gene expression data, the dimension of the simulated datasets was set p=1000 in each implementation, and there were 10 relevant genes with the nonzero coefficients: β₁=1.5, β₄=−1.2, β₇=1, β₁₀=−0.8, β₁₃=0.5, β₁₆=−1, β₁₉=−1, β₂₂=−0.5, β₂₅=1.2, β₂₈=0.8.

The coefficients β of the remaining 990 genes were set to zero. The right censored rate was 30%. The cases have been considered with the training sample size n=100, 150, 200, the correlation coefficient c=0, 0.3 and the noise control parameter s=0.2, 0.6 respectively. The iterative weighted linear programming method for the RS-AFT model does not need to tune the regularization parameter. For other four regularized AFT models (Lasso, L_{1/2}, EN, SCAD), the efficient coordinated descent methods were adopted and their regularization parameters were tuned by the 5-fold cross validation. Each AFT model was evaluated on a test dataset including 50 samples. The results of each procedure averaged over 100 repeats.

Since the AFT model was used to predict the survival time of the patients, the mean squared error (MSE) is more suitable to measure the accuracy of the continuous estimated y′ and observed y,

$$MSE = \frac{1}{n} {\sum }_{i = 1}^{n} {( {y}^{′} - y )}^{2} .$$

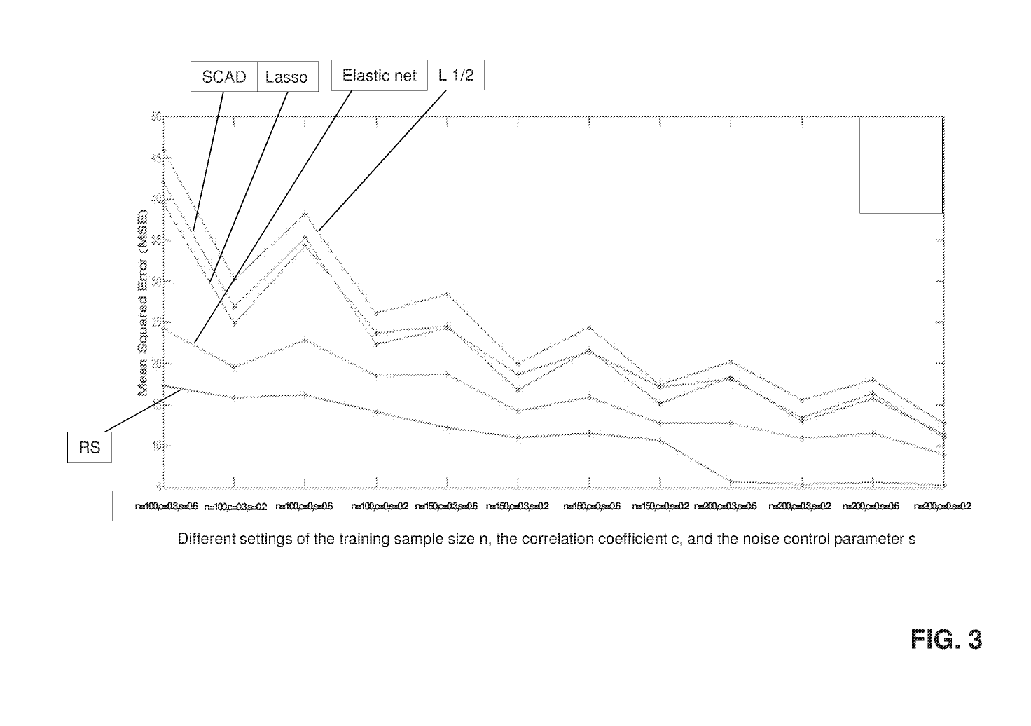

FIG. 3 shows the average MSE obtained by the AFT model with different regularization approaches. The y-axis is the value of MSE, the x-axis represents the different parameter settings of the training sample size n, the correlation coefficient c and the noise control parameter s. As show in FIG. 3, when the sample size n increases, the prediction accuracies of all the five AFT models was improved. For example, when c=0.3, and s=0.2, the average MSE of the RS-AFT model were 15.88, 11.04 and 5.43 with the sample sizes n=100, 150, and 200 respectively. When the correlation parameter c or the noise parameter s increased, the prediction accuracies of all the five AFT methods decreased. For example, when c=0.3 and n=100, the average MSE from the RS-AFT model increased from 15.88 to 17.31, in which s increases from 0.2 to 0.6. When s=0.6 and n=150, the average MSE of the RS-AFT model increased from 11.54 to 12.29, in which c increases from 0 to 0.3. Moreover, in the present simulation, the influence of the noise may be larger than that of the variable correlation for the prediction accuracies of all the five models. On the other hand, at the same parameter setting case, the prediction accuracy of the RS-AFT model is better than the results of the other AFT methods. For example, when c=0.3, s=0.6 and n=200, the averaged MSE of the RS-AFT method is 5.74, and much better than 18.10, 20.29, 12.81 and 18.08 got by the Lasso, L_{1/2}, EN and SCAD methods respectively.

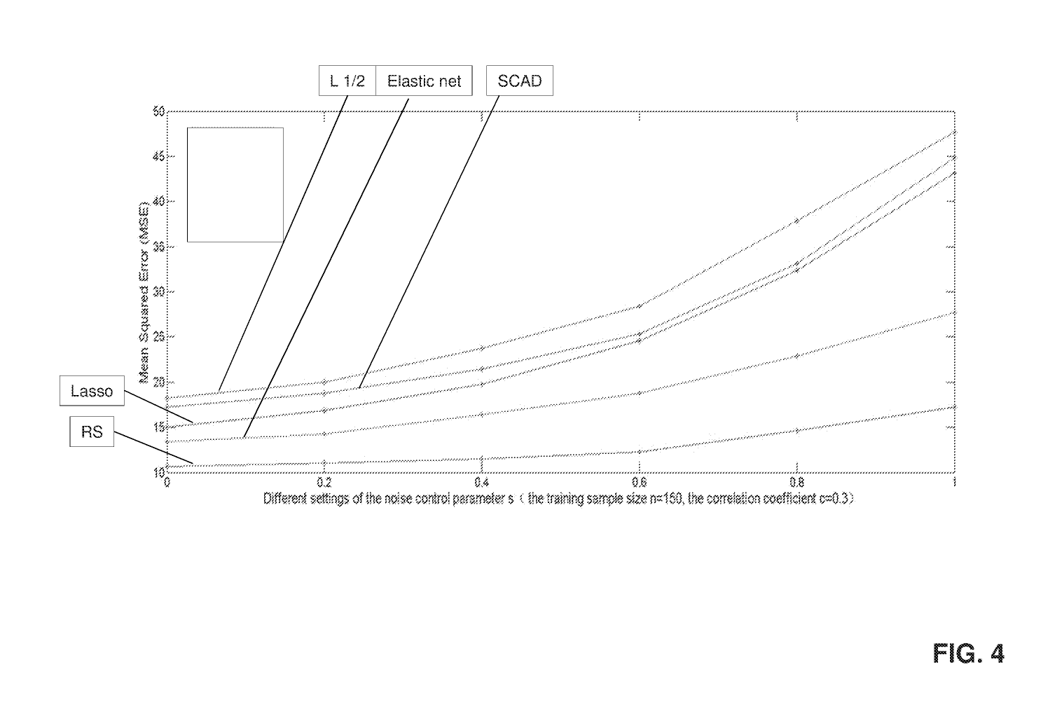

To further demonstrate the advantage of the present RS-AFT model, FIG. 4 shows the performances of the AFT models with various noise settings. In FIG. 4, the x-axis represents the value of noise control parameter s, where n=150 and c=0.3 are fixed. When the noise control parameter was increased from zero to one, the prediction accuracy of all the five AFT models decreased. For example, the averaged MSE of the RS-AFT model increased from 10.64 to 17.19 as the noise increasing. However, the RS-AFT model consistently and stably outperformed other models in the noise data environment. For example, when s=1, the MSE of the RS-AFT model was 17.19, and much smaller than 43.13, 47.69, 27.72, 44.81 obtained by Lasso, L_{1/2}, EN and SCAD respectively. On the other hand, the inventors herein discovered that the MSE of Lasso, L_{1/2} and SCAD were much closed and the Elastic net method has the smallest MSE compared with them. Consequently, the RS-AFT model allows for robust and stable performance when predicting survival time, especially in the high noise environment.

Table 1 shows the number of genes selected by the five AFT models in the different parameter settings. It is obvious that the L_{1/2} method always selects the least number of genes, nevertheless its precision for the correct gene selection is not very high. Conversely, the Elastic net approach invariably selects the highest number of genes, in which the most correct genes are included, except two cases (n=200, c=0.3,s=0.2) and (n=200,c=0,s=0.2). Among the gene selection of the other three regularization methods (RS, Lasso, SCAD), the RS approach occupies first place, SCAD and Lasso come second and third respectively. The inventors herein also found that the number of correct genes selected by these three methods was similar, and the differences are negligible. Moreover, with the decrease of the noise parameter s or the correlation coefficient c, or the increase of the sample size n, the numbers of gene selected by the five AFT models and their precisions of the correct genes selection increased.

TABLE 1
Average number of total genes and correct genes
selected by different AFT methods. In bold-the least results.

| | | Number of total | | | | | | | | | |
|---|---|---|---|---|---|---|---|---|---|---|---|
| | | selected genes | | | | | Number of correct genes | | | | |
| Parameter | | | | | Elastic | | | | | Elastic | |
| setting | | RS | Lasso | L_{1/2} | net | SCAD | RS | Lasso | L_{1/2} | net | SCAD |
| c = 0.3, | n = 100 | 8.29 | 20.28 | 5.12 | 30.14 | 8.68 | 5.32 | 5.57 | 5.12 | 5.71 | 5.29 |
| s = 0.6 | n = 150 | 10.15 | 25.13 | 7.31 | 37.5 | 11.12 | 7.14 | 7.11 | 7.04 | 7.32 | 7.08 |
| | n = 200 | 12.46 | 28.12 | 9.7 | 48.68 | 14.56 | 9.57 | 9.45 | 9.48 | 9.61 | 9.52 |
| c = 0.3, | n = 100 | 7.98 | 16.05 | 5.44 | 27.48 | 8.29 | 5.45 | 5.52 | 5.44 | 5.84 | 5.57 |
| s = 0.2 | n = 150 | 9.75 | 18.24 | 7.28 | 34.77 | 10.58 | 7.26 | 7.38 | 7.28 | 7.66 | 7.34 |
| | n = 200 | 12.13 | 23.43 | 9.85 | 40.43 | 13.83 | 9.71 | 9.65 | 9.74 | 9.7 | 9.69 |
| c = 0, | n = 100 | 8.1 | 18.78 | 5.27 | 28.34 | 8.57 | 5.39 | 5.68 | 5.27 | 5.82 | 5.34 |
| s = 0.6 | n = 150 | 9.91 | 22.08 | 7.24 | 35.51 | 10.86 | 7.26 | 7.17 | 7.1 | 7.43 | 7.2 |
| | n = 200 | 12.21 | 26.69 | 9.71 | 42.53 | 14.09 | 9.66 | 9.55 | 9.57 | 9.68 | 9.6 |
| c = 0, | n = 100 | 7.89 | 15.75 | 5.65 | 26.625 | 8.02 | 5.56 | 5.87 | 5.65 | 6.25 | 5.77 |
| s = 0.2 | n = 150 | 9.63 | 17.74 | 7.5 | 32.38 | 10.19 | 7.45 | 7.52 | 7.5 | 7.74 | 7.54 |
| | n = 200 | 11.98 | 20.74 | 9.97 | 39.13 | 13.52 | 9.82 | 9.79 | 9.85 | 9.84 | 9.89 |

It is evident that a system utilizing the RS-AFT model is the more appropriate and a highly promising approach for survival analysis based on microarray gene expression data, because of its exceptional performance of gene selection, stable noise resistance and the advantageously high prediction precision.

### Example 2

Analysis of Real Data

The different AFT models were applied to four real gene expression datasets respectively, such as DLBCL (2002) (Rosenwald, A. et al., N. Engl. J. Med 346, 1937- 1946), DLBCL (2003) (Rosenwald, A. et al., Cancer Cell 3, 185-197), Lung cancer (Beer, D. G. et al., Nat. Med 8, 816-824.), AML (Bullinger, L. et al., N. Engl. J. Med. 350, 1605-1616). A brief overview on these datasets is given in Table 2.

TABLE 2
Overview on the four real gene expression
datasets used in Example 2.

| | No. of | No. of | No. of | No. of | No. of |
|---|---|---|---|---|---|
| Datasets | genes | samples | censored | training | testing |
| DLBCL (2002) | 7399 | 240 | 102 | 168 | 72 |
| DLBCL (2003) | 8810 | 92 | 28 | 64 | 28 |
| Lung cancer | 7129 | 86 | 62 | 60 | 26 |
| AML | 6283 | 116 | 49 | 81 | 35 |

In order to accurately assess the performance of the five regularized AFT models, the real datasets were randomly divided into two pieces: two thirds of the patient samples were put in the training set used for the model estimation and the remaining one third of the patients' data was used to test the prediction capability. For Lasso, L_{1/2}, EN and SCAD, the regularization parameters are tuned by the 5-fold cross validation. For each real dataset, the AFT model with different regularization procedures was repeated over 50 times respectively.

Table 3 describes the average MSE obtained with the five regularized AFT models in different real gene expression datasets. It is evident that in each dataset, the RS-AFT model obtained the highest prediction precision with the least MSE, which are much lower than that of other AFT models. In addition, the prediction accuracy of the Elastic net approach outperforms Lasso, L_{1/2} and SCAD, and the L_{1/2} approach got the highest MSE.

TABLE 3
MSE obtained by different AFT models
on the real microarray datasets.

| | | | | Elastic | |
|---|---|---|---|---|---|
| Dataset | RS | Lasso | L_{1/2} | net | SCAD |
| DLBCL (2002) | 0.590 | 1.018 | 1.482 | 0.711 | 0.876 |
| DLBCL (2003) | 0.829 | 1.373 | 1.575 | 1.060 | 1.137 |
| Lung cancer | 3.247 | 4.929 | 6.606 | 4.241 | 5.592 |
| AML | 5.883 | 7.507 | 8.164 | 5.271 | 8.167 |

In bold - the least error.

The relevant gene selection of different AFT models on the four real datasets is provided in Table 4. The number of genes selected by the L_{1/2} approach is the least compared with other four penalized methods. The results of the RS-AFT are second-least and much closer to the results of L_{1/2}. The third-least one is the number of genes selected by SCAD method. The genes selected by the Lasso and the Elastic net approaches are much more compared with the RS-AFT, L_{1/2} and SCAD methods.

TABLE 4
Gene selection results of different AFT
models on the real microarray datasets.

| | | | | | Elastic |
|---|---|---|---|---|---|
| Dataset | RS | Lasso | L_{1/2} | SCAD | net |
| DLBCL (2002) | 68 | 131 | 60 | 73 | 168 |
| DLBCL (2003) | 29 | 83 | 26 | 30 | 109 |
| Lung cancer | 28 | 86 | 22 | 39 | 102 |
| AML | 33 | 110 | 39 | 68 | 152 |

In bold - the least number of genes selected.

In the light of the results shown in Tables 3 and 4, it seems for the AFT models with Lasso, L_{1/2}, Elastic net and SCAD regularization approaches that a method having higher prediction accuracy, at same time, selects more genes. For example, the Elastic net method has the highest prediction accuracy among these four methods, meanwhile, selects the highest number of genes. Conversely, the L_{1/2} approach selects the least number of genes, but has the lowest prediction accuracy. However, compared with these four regularized AFT methods, the RS-AFT method can obtain the highest prediction accuracy for survival analysis using relative small number of genes which is a very important consideration in the clinical application for survival time prediction and relevant gene selection.

For biological analysis of the AFT methods, 15 top-ranked selected genes obtained by the different five AFT models in the lung cancer dataset are shown in Table 5. Compared with the other AFT models based on the least squares approaches with different regularization methods, the RS-AFT method selected more unique genes, such as SMAD4, ENPP2, LLGL1. SMAD4 belongs to the Smad family which are signal transduction proteins. The Smad family proteins play a key role in transmitting the TGF-beta signals from the cell-surface receptor to cell nucleus, mutation or deletion of SMAD4 has been proved to lead to the pancreatic cancer (Boone, B. A. et al., J Surg Oncol, 110(2):171-5). It is expected that they are strongly associated with the lung cancer. ENPP2 is also known as ATX and this gene product has the effect of stimulating the motility of tumour cells. The expression of ENPP2 has been found to be upregulated in some different kinds of cancers (Umezu-Goto, M. et al., J. Cell Biol. 158 (2): 227-33). The protein encoded by the gene LLGL1, is said to be very similar to the tumour suppressor of drosophila, and is a highly relevant gene to cancer (Schimanski, C.C. et al., Oncogene 24 (19): 3100-9). Moreover, some relevant genes selected by other AFT models with Lasso, L_{1/2}, Elastic net and SCAD, were also found by the RS-AFT, for example, TRA2A, WWP1, DOC2A and HUWE1. They have been discussed in Chai, et al. (The L_{1/2} regularization approach for survival analysis in the accelerated failure time model, Comput. Biol.Med., 2014), and are significantly associated with lung cancer.

Similar results were obtained from the analysis of the other three real gene expression datasets. The biological analysis confirm that the RS-AFT model is not only able find the relevant genes which are selected by other AFT models, but also can find some unique genes, which are not selected by other AFT models and are also significantly associated with the disease. Hence, the RS-AFT model is suitable to identify the relevant genes accurately and efficiently.

TABLE 5
The 15 top-ranked informative genes found by the
five AFT methods from the lung cancer dataset

| | | | | Elastic | |
|---|---|---|---|---|---|
| rank | RS | Lasso | L_{1/2} | net | SCAD |
| 1 | SMAD4 | WWP1 | WWP1 | TRA2A | WWP1 |
| 2 | ENPP2 | HUWE1 | TRA2A | WWP1 | TRA2A |
| 3 | TRA2A | TRA2A | HUWE1 | CCL21 | HUWE1 |
| 4 | LLGL1 | CCL21 | DOC2A | HUWE1 | CCL21 |
| 5 | WWP1 | ADM | RPL36AL | ADM | ADM |
| 6 | DYNLT3 | PBXIP1 | PHKG1 | RPL36AL | PHKG1 |
| 7 | DOC2A | RPS29 | CCL21 | HLA-C | HLA-C |
| 8 | HUWE1 | TNNC2 | ADM | PEX7 | RPS29 |
| 9 | TEK | DOC2A | RPS29 | ZNF148 | DOC2A |
| 10 | PHKG1 | HLA-C | HLA-C | INHA | ATRX |
| 11 | PFN1 | HTR6 | PRKCSH | RPS29 | ENPP2 |
| 12 | RPL23 | TFAP2C | RAD23B | DOC2A | ZNF148 |
| 13 | ENPP2 | ZNF148 | HUMBINDC | SERINC3 | TFAP2C |
| 14 | POLR2A | HUMBINDC | MYOG | GNS | TNNC2 |
| 15 | CFTR | RPL36AL | TFAP2C | ATRX | RAD23B |

1. A method for determining an estimated survival time of a subject with a medical condition, comprising the steps of:
obtaining a dataset comprising biological data of a plurality of sample subjects, the biological data of each sample subject includes one or more biological features and a time value associated with a survival time;
applying at least part of the dataset to a parametric survival model to solve the parametric survival model by determining one or more parameters in the parametric survival model; and
processing biological data of a sample subject with the medical condition with the solved parametric survival model to determine an estimated survival time of the sample subject;
wherein the parametric survival model is a modified accelerated failure time model that applies least absolute deviation and L_{q}-type regression method with 0<q≦1.

2. The method in accordance with claim 1, wherein in the processing step, the estimated survival time of the sample subject is determined based on one or more biological features in the biological data of the sample subject.

3. The method in accordance with claim 1, wherein the biological data of each of the plurality of sample subjects is in a form of:
(yᵢ,δᵢ,xᵢ)ᵢ₌₁ⁿ
where yᵢ=min(tᵢ,cᵢ) with yᵢ being the time value associated with the survival time, tᵢ being a real survival time and cᵢ being a censoring survival time, of an i^{th} sample subject; 5 is a censoring indicator in which δᵢ=0 represents a right-censoring time, and δᵢ=1 represents a real completed time; xᵢ=(xᵢ₁, . . . xᵢₚ) are p dimensional covariates representing the one or more biological features of the i^{th} sample subject.

4. The method in accordance with claim 3, wherein the parametric survival model is defined by at least in part by
h(yᵢ)=xᵢ^{T}β+εᵢ, i=1, . . . ,n
where function h( ) is a monotone function; εᵢ are independent random errors with a normal distribution function; and β=(β₁,β₂, . . . ,βₚ) is the regression coefficient vector of p variables representing the one or more parameters to be determined.

5. The method in accordance with claim 4, wherein the function h( ) is a logarithmic function.

6. The method in accordance with claim 4, wherein the one or more parameters are determined at least in part by:
$${β}_{LAD} = argmin \{ {\sum }_{i = 1}^{n} \vert h ( {y}_{i} ) - {x}_{i}^{T} β \vert + {\sum }_{j = 1}^{p} λ {\vert {β}_{j} \vert}^{q} \}$$
with 0<q≦1, and λ is an optimization parameter.

7. The method in accordance with claim 4, wherein for δᵢ=0, the method further comprises the steps of:
determining an estimated model survival time using the censoring survival time based on Kaplan-Meier estimation method, where
$$h ( {y}_{i} ) = ( {δ}_{i} ) h ( {y}_{i} ) + ( 1 - {δ}_{i} ) {\{ \hat{S} ( {y}_{i} ) \}}^{- 1} {\sum }_{{t}_{( r )} > t} h ( {t}_{( r )} ) Δ \hat{S} ( {t}_{( r )} )$$
with h(yᵢ) being the estimated model survival time; yᵢ being the censoring survival time; and ΔŜ(t₍ᵣ₎)) is a step function at time t(r); and
applying the estimated model survival time to the parametric survival model to facilitate determination of the one or more parameters in the parametric survival model.

8. The method in accordance with claim 6, further comprising the step of:
determining the optimization parameter λ using Bayesian information criterion.

9. The method in accordance with claim 8, wherein the optimization parameter λ is determined as:
$$λ = \frac{log ( n )}{{\vert {β}_{LAD} \vert}^{q}}$$
with 0<q≦1.

10. The method in accordance with claim 1, further comprising the step of:
solving the parametric survival model to determine an effect of the one or more biological features on the estimated survival time.

11. The method in accordance with claim 10, wherein the parametric survival model is solved using a weighted iterative linear programming method.

12. The method in accordance with claim 11, wherein the weighted iterative linear programming method comprises the steps of:
setting t=0 and β^{t}=β_{LAD} for t=0;
determining the values of β^{t+1} using
$${β}^{t + 1} = argmin \{ {\sum }_{i = 1}^{n} \vert h ( {y}_{i} ) - {x}_{i}^{T} β \vert + {\sum }_{j = 1}^{p} \frac{log ( n )}{\vert {β}_{j}^{t} \vert} \vert {β}_{j} \vert \} ;$$
and
iterating the β^{t} value determination step for increasing value of t until a convergence criterion is met.

13. The method in accordance with claim 1, wherein the sample subjects are humans; the one or more biological features are: presence of a gene, gene expression, presence of a gene product or amount of a gene product; and the medical condition is cancer.

14. A system for determining an estimated survival time of a subject with a medical condition, comprising one or more processors arranged to:
apply a dataset that comprises biological data of a plurality of sample subjects to a parametric survival model to solve the parametric survival model by determining one or more parameters in the parametric survival model , wherein the biological data of each sample subject includes one or more biological features and a time value associated with a survival time; and
process biological data of a sample subject with the medical condition with the solved parametric survival model to determine an estimated survival time of the sample subject based on one or more biological features in the biological data of the sample subject;
wherein the parametric survival model is a modified accelerated failure time model that applies least absolute deviation and L_{q}-type regression methods with 0<q≦1.

15. The system in accordance with claim 14, wherein the biological data of each of the plurality of sample subjects is in a form of:
(yᵢ,δᵢ,xᵢ)ᵢ₌₁ⁿ
where yᵢ=min(tᵢ,cᵢ) with yᵢ being the time value associated with the survival time, tᵢ being a real survival time and cᵢ being a censoring survival time, of an i^{th} sample subject; 5 is a censoring indicator in which δᵢ=0 represents a right-censoring time, and δᵢ=1 represents a real completed time; xᵢ=(xᵢ₁, . . . xᵢₚ) are p dimensional covariates representing the one or more biological features of the i^{th} sample subject.

16. The system in accordance with claim 15, wherein the parametric survival model is defined by at least in part by
h(yᵢ)=xᵢ^{T}β+εᵢ, i=1, . . . ,n
where function h( ) is a logarithmic function; εᵢ are independent random errors with a normal distribution function; and β=(β₁,β₂, . . . ,βₚ) is the regression coefficient vector of p variables representing the one or more parameters to be determined.

17. The system in accordance with claim 16, wherein the one or more processors are arranged to determine the one or more parameters based at least in part on:
$${β}_{LAD} = argmin \{ {\sum }_{i = 1}^{n} \vert h ( {y}_{i} ) - {x}_{i}^{T} β \vert + {\sum }_{j = 1}^{p} λ {\vert {β}_{j} \vert}^{q} \}$$
with 0<q≦1, and λ is an optimization parameter.

18. The system in accordance with claim 14, wherein the one or more processors are arranged to solve the parametric survival model using a weighted iterative linear programming method and to determine an effect of the one or more biological features on the estimated survival time.

19. The system in accordance with claim 14, wherein the sample subjects are humans; the one or more biological features are: presence of a gene, gene expression, presence of a gene product or amount of a gene product; and the medical condition is cancer.

20. The system in accordance with claim 14, further comprising a display arranged to display the determined estimated survival time of the sample subject.
